(19) United States
(12) Patent Application Publication
(10) Pub. No.: US 2006/0027449 A1
(43) Pub. Date: Feb. 9, 2006

(54) Mechanism and assembly process of a dust/small particles-proof starting switch for rotary electric machines

(75) Inventors: Marcelo de Melo Silva, Jaragua do Sul (BR); Valmir Luis Stoinski, Jaragua do Sul (BR)

Correspondence Address: DARBY & DARBY P.C., P. O. BOX 5257, NEW YORK, NY, 10150-5257, US

(73) Assignee: WEG INDUSTRIAS S.A.

(21) Appl. No.: 11/077,639

(22) Filed: Mar. 10, 2005

(30) Foreign Application Priority Data
Aug. 5, 2004 (BR) PI 0404228-0

(51) Int. Cl. H01H 9/04

(52) U.S. Cl. 200/302.1

(57) ABSTRACT

Invention patent of the mechanism and of the assembly process of a dust /small particles-proof starting switch for rotary electric machines, which aim is to provide an-easy-to-assemble system for the several components aggregated to that mechanism, without huge investment when compared to the remaining systems currently in operation in the market, making this assembly simple due to the particularities of each component herein contained.

The present invention patent refers to a protection system against dust for a starting switch of rotary electric machines and its assembly process.

Protections to starting switches have been studied for years by several manufacturers of electric machines as those kinds of starting switches are operated in several different environments, including environments with chemical substances and weird particles. Other environments may have high humidity levels, and the combination of those contaminant elements may speed up the deterioration of the active components, impairing good and preventing the long life required. Typically, we can use a rotary electric machine to operate a saw or a similar equipment where the environment is very aggressive due to wood chip and dust resulting from the cutting process. In yet another case, we analyzed an environment where cotton thread is manufactured. An environment where we have small particles of cotton in suspension, and when in contact with the energized parts they may cause combustion due to the occurrence of sparks in the starting switch during its operation. Another example is in nautical applications, where the presence of salt spray penetrates components of the electric machine, causing premature corrosion of the conductive parts. Another concern is the presence of bugs in some applications; they end up penetrating the equipment and settling near the electric contact parts, lately impairing its operation. Open electric machines have been used since the old times as they are cheaper and more compact. In this case, a solution for those environments would be the use of a enclosed electric machine. However, besides the difficulty to remove heat from this type of construction, the increase in the manufacturing costs of such equipment becomes evident as we normally need to use more material to obtain the same power from the equipment due to the loss by heat. The size, costs related to the increase of copper, sheet steel and weight are the main consequences of the use of sealed motors, and are good reasons for the use of open electric machines where applications allow, even in contaminated environments that may affect performance or degradation, being the economic feasibility of each application analyzed case by case. Several types of motors usually used in the descriptions and examples above have a starting capacitor or are of the split-phase type. To start single-phase motors of that type of construction, it is necessary to have an auxiliary coil to help starting the motor until it reaches the working speed. At that moment, they are usually actuated by a centrifugal activating disk, it is necessary to switch off the starting winding, which is necessary in those types of motors. That centrifugal actuator is fixed to the motor shaft, and when in its axial displacement, designed for that purpose and at the right time, that is, when the ideal rotation of the is reached, releases the electric contact, opening that connection and switching off the starting winding. From that point on, the main winding has enough torque for the full operation of the motor. If the starting winding does not actuate together with the starting switch and the centrifugal actuator, it characterizes motor failure and the need of maintenance and cleaning of the set. That causes losses and inconveniences in its operation. Therefore, it is the desire of all that set be robust and of low maintenance, preferably that there was no such need. Several types of starting switches are similar in their operation, as in the American patent U.S. Pat. No. 4,289,988. Others already have protection systems as in American patent U.S. Pat. No. 2,816,199 and U.S. Pat. No. 4,927,988, which are also characterized by being dust-proof mechanisms.

Usually, the sets (U.S. Pat. No. 2,816,199 e U.S. Pat. No. 4,927,988) are characterized by containing a bronze-alloy, a thin flexible plate, or another good conductor resistant to voltaic arcs, by being fixed on one side to a base that contains a cylindrical contact of silver alloys or another excellent conductor, and when under a static status they press another cylindric contact of silver alloys in order to command, through the centrifugal actuator, their opening and the closing, starting or switching off the starting winding. In more modern protection systems against dust, they try to insulate the gap among them in order to keep the contact surfaces clean when of starting. When the sets are compared to those listed in the state of art, we can also observe a flexible cylindric anatomic structure in other similar systems as in the case of American patent U.S. Pat. No. 4,927,988.

In particular, the present invention aims at adding to those systems a unique assembly, adequate to process needs for simplicity and handling easiness, being comprised mainly of a silicone casing especially resistant to voltaic arcs which is placed between the contacts, and which differs from the state of art as it is provided in one end with an elongated transversal opening, dimensioned in such as way as to facilitate the introduction of one of the silver alloy contacts together with a connection bridge riveted among themselves, and which is provided in the other end with a thicker ring in order to be fitted to the neck of the other silver alloy contact. Its main function is to keep the silver contacts closed and to allow them to move in a way that does not significantly interfere with the forces acting on the actuating blade of the contact points.

Another aim of the present invention foresees a connection bridge with rounded ends to protect and facilitate the introduction of the silver contact, riveted to the bridge itself inward the silicone casing.

Still another aim of the present invention is to obtain an assembly process that facilitates the introduction of the casing and of the connection bridge by means of a base developed with a more outstanding orifice, providing room to handle the centrifugal set during assembly.

The said invention also presents a great advantage as this protection (particles-proof mechanism) allows small changes in the internal room of the motor.

The operation mode of the devices is shown in the enclosed drawings, which reveal the preferred construction of the present invention, without deviating from the scope of the present invention:

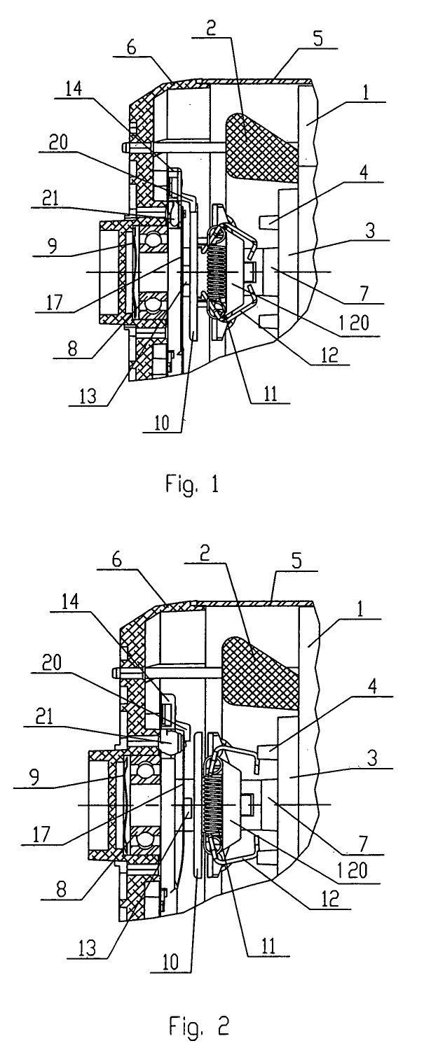

FIG. 1 is a partial section view of an electric motor using the present invention, showing its position on the shaft of an electric motor.

FIG. 2 is a partial section view of an electric motor using the present invention, showing its position on the shaft of an electric motor, however with the contact in open position and the motor at operating mode.

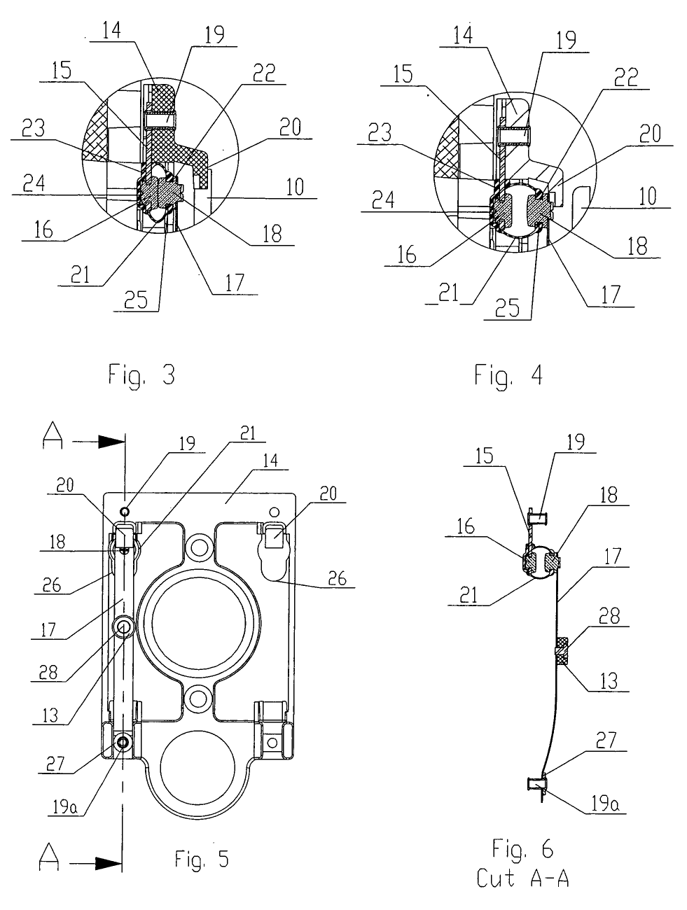

FIG. 3 is a cross section view showing the casing region of FIG. 1, with the motor at rest mode.

FIG. 4 is a cross section view showing the casing region of FIG. 2, with the motor at full operation mode.

FIG. 5 is a front view of the present invention assembled on the base plate of the contact points.

FIG. 6 is a section view of cut A-A indicated in FIG. 5 without the base plate, showing the mechanism assembly of a starting switch that is small particles/dust-proof to be used in rotary electric machines.

With reference to FIG. 1, an electric motor is shown in cut view in order to clarify the operation principle and the way the components involved in this process act, which consists of helping the starting of a single-phase induction motor. One can see an induction stator 1, the induction stator winding followed by a squirrel cage rotor 3 and balance pins 4 of the rotor 3. These are the main components of a motor, with squirrel cage rotor 3. To support its operation, there is the frame 5 where the stator 1 is fit into by dimensional interference, by its inside diameter and where the cover 6 is fit in order to axially support the set through a bearing 8, wave washer 9 and shaft 7, which closes the cycle, being that assembled to the rotor 3 through dimensional interference.

The switching on and off system of the auxiliary winding 2 is done by two components, being the first the centrifugal set 120, which actuates through an actuator disk 10 which through springs 11 and the centrifugal support 12 when the ideal speed previously dimensioned is reached, is opened through a centrifugal force and displaces the actuator disk 10, which releases the prop washer 13 of low friction material, displacing the blade 17 and the bimetallic contact 18 responsible for the connection of the auxiliary winding 2 and switching off the same coil 2.

With reference to FIG. 3, the second component is the switch 20, which is a interrupter comprised of a base 14 made of a material resistant to humidity and that is a good thermal insulation, and which through electrical feeding on one side, connected to a bridge 15 and to a conductive electrical contact 16 form one side of the switch. The bridge 15 is fixed to the base through rivet 19, and on the opposite side a blade 17 of conductive material, together with the other conductive electrical contact 18, form the other side of that switch.

Still in FIG. 3, there is the main component and object of the invention: the casing 21. It is responsible for providing protection against the entry of small dust particles or dirt. It is fixed to the contact 18 through a neck 22 in contact 18 together with ring 25 of the casing 21 and is fixed to the other contact 16 and to the bridge 15 through an elongated opening 23. The said contact 16 also has a rivet 24 done on the bridge 15 in such a way that there is no sharp edge or burr. It is important to point out that the casing 21 remains compressed when the motor is at rest, and it goes back to its original position when the motor is operating.

With reference to FIG. 2, it follows the whole operation principle of FIGS. 1 and 3. It shows, however, the casing 21 in its open position.

With reference to FIG. 4, it follows the same principles of FIG. 2, showing in detail contacts 16 and 18 in their open position, that is, when the motor reaches its ideal speed to switch off the auxiliary coil 2, the centrifugal set 120 displaces the actuator disk 10 together with the prop washer 13, the blade 17 and the contact 18, displacing the said contact 18 from contact 16 and stretching the casing 21.

With reference to FIGS. 5 and 6, we can observe the base 14 with a housing opening 26 of the casing 21, which allows great easiness in the assembly process, where you can accommodate at one time the bridge 15, the contact 16 accompanied by the casing 21, the contact 18, the blade 17, the prop washer 13, a rivet 28 and a washer 27, previously sub-assembled, and then riveting those components to rivets 19 and 19a, as in the assembly representation (Cut A-A) showed in FIG. 6, which represents the assembly process of a dust/small particles-proof starting switch for rotary electric machines as in the assembly process that follows:

Pre-Assembly 1:

Rivet contact 16 to bridge 15;
Rivet contact 18 to blade 17;
Rivet with rivet 28 the prop washer 13 to the blade 17;
   Pre-Assembly 2:
Assemble the casing 21 so as to involve contact 16 and contact 18, previously pre-assembled;
   Final Assembly:
Introduce the pre-assembly set 2 to the base 14, going through the opening 26 of the casing housing 21;
Rivet the pre-assembly set 2 to the base 14, adding the washer 27 and rivets 19 and 19a.

1. Mechanism of a dust/small particles-proof starting switch for rotary electric machines, which comprises an auxiliary winding, dimensioned to be turned on and off together with the starting switch during the working speed stage of the rotary electric machine, a mechanical starting switch containing two cylindrical conductive contacts that remain in contact when of the starting of the motor and after working speed is reached are moved away causing the switching off of the auxiliary starting winding of the motor; the said cylindrical conductive contacts are axially displaced by means of an actuating disk due to the force of a centrifugal device with a spring system characterized by the fact that it comprises a casing with an opening of elongated profile that facilitates the initial introduction of the assembly to one of the conductive contacts, protecting the connection bridge and the conductive contacts.

2. Mechanism of a dust/small particles-proof starting switch for rotary electric machines, according to claim 1, characterized by the fact that the casing is preferably in the convex form of thin walls in order to yield with minimum resistance to the movement of the conductive contacts and at the same time, insulating the external environment from the conductive contacts area.

3. Mechanism of a dust/small particles-proof starting switch for rotary electric machines, according to claim 1, by the fact that it is assembled on the conductive contacts, one convex casing of adequate material so as to protect them against the entry and build up of dust particles.

4. Mechanism of a dust/small particles-proof starting switch for rotary electric machines, according to claim 1, characterized by the fact that it is provided with a connection bridge of oblong form, allowing the fitting and assuring the assembly of the mentioned casing, which for being extremely thin, allows no burrs at all for its best performance and durability.

5. Mechanism of a dust/small particles-proof starting switch for rotary electric machines, according to claim 1, characterized by the fact that it has rounded riveting in the conductive contact assembled to the connection bridge.

6. Mechanism of a dust/small particles-proof starting switch for rotary electric machines, according to claim 1, characterized for having the conductive contact opposite the connection bridge dimensioned with a fitting ring so as to provide adequate coupling to the other side of the casing.

7. Mechanism of a dust/small particles-proof starting switch for rotary electric machines, according to claim 1, characterized for having in its structural base one predominantly oblong opening of the casing housing that allows great easiness in the assembly process.

8. (canceled)

9. Assembly process of a dust/small particles-proof starting switch for rotary electric, characterized for comprising the following distinct steps:
First assembly step: riveting the first cylindrical conductive contact to the connection bridge. Then riveting the first cylindrical conductive contact to the flexible conductive blade. After that, also riveting the prop washer to the flexible conductive blade.
Second assembly step: assembling the casing so as to involve both the first and the second flexible conductive contacts, thus obtaining an assembly formed by blade, contacts, bridge and casing which will later be introduced into the support base of the starting switch, going through a predominantly oblong opening which works as the housing of the casing; and
Third assembly step: riveting the assembly from the previous step, formed and introduced into the support base of the starting switch, to the washer finishing the assembly process of the mechanism of a dust/small particles-proof starting switch for rotary electric machines.
